(19) United States
(12) Patent Application Publication
(10) Pub. No.: US 2016/0248645 A1
(43) Pub. Date: Aug. 25, 2016

(54) SUMMARY METRICS FOR TELEMETRY MANAGEMENT OF DEVICES

(71) Applicant: ARRIS Enterprises, Inc., Suwanee, GA (US)

(72) Inventor: Harindranath P. Nair, Hillsboro, OR (US)

(21) Appl. No.: 14/628,524

(22) Filed: Feb. 23, 2015

(51) Int. Cl. H04L 12/26; H04B 3/46

(52) U.S. Cl. CPC H04L 43/045; H04L 43/06; H04L 43/50; H04B 3/46

(57) ABSTRACT

The methods, systems, and apparatuses described in this disclosure enable the reporting and monitoring of summarized metrics for a plurality of carriers. Metrics for one or more of a plurality of carriers can be observed and/or recorded based on measurements taken of one or more signals received along one or more of the plurality of carriers. Observed metrics may be sorted according to an associated carrier. A summary of observed metrics may be generated such that the metric summary can provide a glimpse of the quality of the carriers and an alert of any issues that might exist on the carriers.

### TECHNICAL FIELD

This disclosure relates to monitoring metrics for observed signals.

### BACKGROUND

The Data-Over-Cable Service Interface Specification (DOCSIS) was established by cable television network operators to facilitate transporting data traffic, primarily Internet traffic, over existing community antenna television (CATV) networks. In addition to transporting data traffic, as well as television content signals over a CATV network, multiple services operators (MSO) also use their CATV network infrastructure for carrying voice, video on demand (VoD) and video conferencing traffic signals, among other types. Similarly, telecommunications companies (telcos) have expanded their offerings into high speed data and video offerings.

Services may be delivered to subscribers as signals transported over multiple carriers (e.g., channels, bands, etc.). For example, MSOs may use orthogonal frequency division multiplexing (OFDM) to provide services to network devices over a larger number of narrow sub-carriers (e.g., 25 KHz subcarriers in a 192 MHz channel width) that are individually modulated, rather than the smaller number of wider channels (e.g., 32 6 MHz carriers) used in other technologies.

To assure the quality of services provided over these channels, metrics are typically collected about the observed signals on each of these carriers. However, a larger number of carriers, such as the larger number of sub-carriers resulting from OFDM, leads to the scenario where a network device reports a large volume of telemetry for these channels. The reporting of this large telemetry volume significantly increases the overhead on the devices and network. Dense telemetry of a common kind can also occur in other situations. For example, a traditional 6 MHz channel on a cable modem termination system (CMTS) has multiple devices attached to it, and the CMTS needs to report metrics for all of them, which can create a significant overhead on the CMTS.

Subscriber devices may observe and record metrics, and may be configured with thresholds to allow the device to determine the quality of the metric. The subscriber device may then return a health indicator to a management agent. However, determining the health of a subscriber device at the device itself requires preset configuration of the devices in the field, leading to inflexibility in determining thresholds and operational difficulties in adjusting thresholds. Therefore, a need exists for improving methods and systems for reporting signal metrics in a network.

### BRIEF DESCRIPTION OF THE DRAWINGS

FIG. 1 is a block diagram illustrating an example network environment operable to summarize metrics for a plurality of carriers.

FIG. 2 is a block diagram illustrating an example system operable to summarize metrics for a plurality of carriers.

FIG. 3 is a flowchart illustrating an example process operable to summarize metrics for a plurality of downstream carriers.

FIG. 4 is a flowchart illustrating an example process operable to summarize metrics for a plurality of upstream carriers.

FIG. 5 is a block diagram of a hardware configuration operable to summarize metrics for a plurality of carriers.

Like reference numbers and designations in the various drawings indicate like elements.

### DETAILED DESCRIPTION

It is desirable to improve upon methods and systems for reporting signal metrics in a network. The methods, systems, and apparatuses described in this disclosure enable the reporting and monitoring of summarized metrics for a plurality of carriers. A carrier as described herein may be any vessel for transporting signals between an upstream network component and a client device. For example, a carrier may be an upstream or downstream channel, a bonded channel group, an individual narrow sub-carrier, a group of sub-carriers making up an upstream or downstream channel, and others. Metrics for one or more of a plurality of carriers can be observed and/or recorded based on measurements taken of one or more signals received along one or more of the plurality of carriers. Observed metrics may be sorted according to an associated carrier. A summary of observed metrics may be generated such that the metric summary can provide a glimpse of the quality of the carriers and an alert of any issues that might exist on the carriers.

In embodiments, simple descriptive statistics may be retrieved for each metric. Retrieval of descriptive statistics may be accomplished using various techniques, protocols, and standards, including, but not limited to the addition of management information base (MIB) objects. Rather than retrieving all radio frequency (RF) telemetry for each sub-carrier of a channel, a management application may retrieve the descriptive statistics associated with the metrics of the sub-carriers. The particular statistics to be recorded and/or retrieved may be configured to provide desired insight into the measured telemetry. For example, in the case of OFDM channels for cable devices, the retrieved statistics may include an average and/or percentile values (e.g., the median, 5th and 95th percentile values for each RF metric). A management application may retain and/or adjust desired metric thresholds, thereby allowing each application to use uniquely configured thresholds that are appropriate for the application, and further allowing quick and simple changes to signal or carrier quality estimates without affecting device configuration.

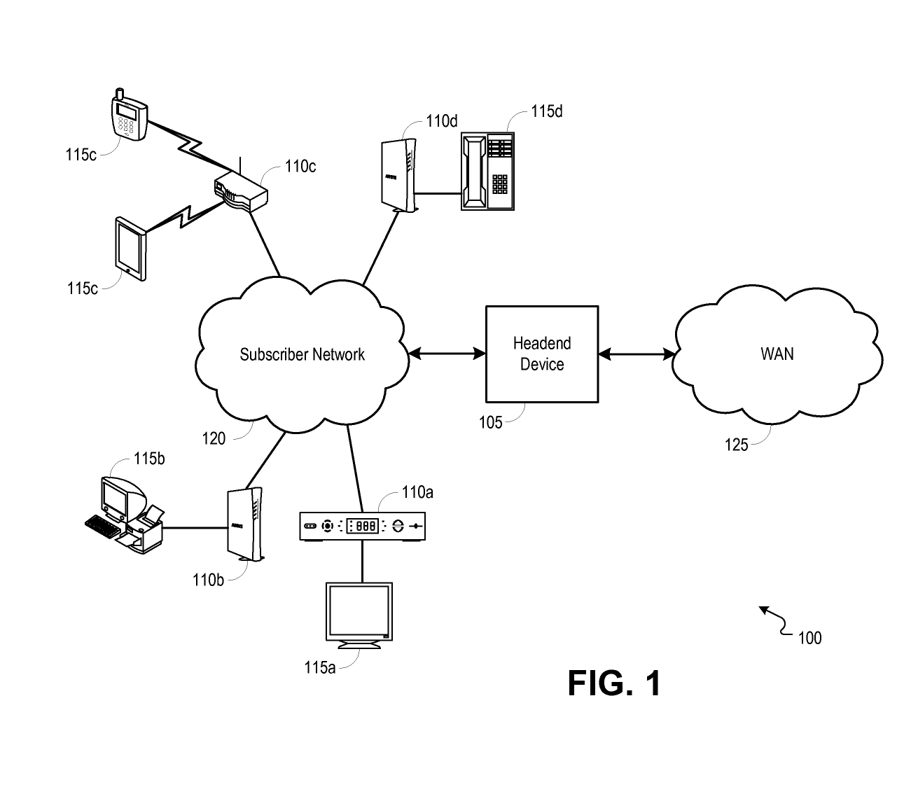

FIG. 1 is a block diagram illustrating an example network environment 100 operable to summarize metrics for a plurality of carriers. In some implementations, a headend device 105 can provide video, data and/or voice service(s) to customer premise equipment (CPE) devices 110a-d in one or more subscriber groups (e.g., service group(s)). The CPE devices can include, for example, a set-top box (STB) 110a, a cable modem 110b, a wireless router including an embedded cable modem 110c, or a media terminal adapter (MTA) 110d, among many others (e.g., gateway device, digital subscriber line (DSL) modem, voice over internet protocol (VoIP) terminal adapter, video game console, digital versatile disc (DVD) player, communications device, etc.). A set top box 110a can facilitate communications between the headend device 105 and a television 115a or a separate digital video recorder (DVR). A cable modem or embedded MTA (eMTA) 110b can facilitate communications between the headend device 105 and a wired terminal 115b (e.g., computer). A wireless router 110c can facilitate wireless communications between a wireless device 115c (e.g., computer, mobile device, tablet, etc.) and the headend device 105. An MTA 110d can facilitate communications between a telephone 115d and the headend device 105.

The CPE devices 110a-d can communicate with the headend device 105 via a subscriber network 120 (e.g., hybrid fiber-coax (HFC) network, twisted-pair network, mobile communications network, etc.). The headend device 105 can include devices such as a cable modem termination system (CMTS) and/or an edge quadrature amplitude modulation (EQAM) device, or a combined or converged device including multiple edge and/or video or data processing functionalities. Such devices can operate to facilitate communications between a wide-area network (WAN) 125 and the CPE devices 110a-d. In embodiments, the WAN 125 can include one or more networks internal to the headend and/or one or more networks external to the headend (e.g., one or more extranets, the Internet, etc.).

In embodiments, the CMTS can forward packets destined for subscribers to an EQAM device used to modulate the signal onto one or more carrier waveforms. The carrier waveforms can include both data and video streams, in both multicast and unicast (e.g., point-to-point) formats for transmission to a combiner, which can combine multiple signals onto a single fiber for transmission to one or more CPE devices 110a-d via the subscriber network 120. In embodiments, received signals may be modulated onto a plurality of narrow sub-carriers using orthogonal frequency division multiplexing (OFDM), and the signals may be delivered to one or more CPE devices 110a-d along the plurality of downstream sub-carriers. CPE devices 110a-d can output upstream communications to the headend device 105 using one or more upstream channels.

In embodiments, a CPE device 110a-d may be configured to measure and record a metric associated with signals received along each of a plurality of downstream sub-carriers. For example, a CPE device 110a-d may measure and record the power level (e.g., transmit and receive power level), signal-to-noise ratio (SNR), errors (e.g., pre and post forward error correction (FEC) error counts), group delayed micro-reflection metrics, and other metrics associated with a signal received at the CPE device through a downstream sub-carrier.

In embodiments, a CPE device 110a-d may sort metrics according to individual sub-carriers. The CPE device 110a-d may sample and record one or more metrics for each of a plurality of sub-carriers at a certain rate. For example, a record may be maintained for each sub-carrier, wherein the record includes values of metric samplings observed for the sub-carrier over a certain duration. Metrics may be sorted according to a channel associated with the sub-carriers. As another example, to improve the speed of sorting metric samples and determining metric statistics, a quick-select or variant algorithm may be used to sort metric samplings for a sub-carrier until a sufficient number of samplings have been recorded to identify one or more desired percentiles (e.g., fifth percentile and ninety-fifth percentile, etc.). As yet another example, a histogram (e.g., frequency histogram) may be used to sort metric samplings observed for a group of sub-carriers. A channel may include more sub-carriers than the number of telemetry values within a range of telemetry values observed over a group of sub-carriers.

A CPE device 110a-d can periodically generate a summary of a metric observed for one or more individual sub-carriers. For example, the CPE device 110a-d can sample and record a metric for a sub-carrier at a certain rate (e.g., metric can be recorded over a certain time duration, a packet burst, etc.), and a summary of the sampled metrics for the sub-carrier can be generated. The CPE device 110a-d can sample and record metrics for each sub-carrier associated with a channel, and a summary of the metrics for the channel may be generated based upon the metrics observed for each of the sub-carriers making up the channel. The metric summary may be the mean value of metric samples recorded over a certain duration. In embodiments, the metric summary may be one or more percentiles (e.g., fifth percentile and ninety-fifth percentile, etc.) associated with the samples recorded for a metric. For example, a histogram associated with a metric may be used to determine one or more percentiles when a sufficient number of samples have been added to the histogram. The metric summary may be an entire histogram including measurements take for a metric associated with one or more sub-carriers.

In embodiments, the headend device 105 may be configured to measure and record a metric associated with signals received along each of a plurality of upstream channels. For example, the headend device 105 may measure and record the power level, signal-to-noise ratio, errors, and other metrics associated with a signal received at the headend device through an upstream channel.

In embodiments, the headend device 105 may sort metrics associated with individual upstream channels. The headend device 105 may sample and record one or more metrics for each of a plurality of channels at a certain rate. For example, a record may be maintained for each channel, wherein the record includes values of metric samplings observed for the channel over a certain duration. As another example, a quick-select or variant algorithm may be used to sort metric samplings for a channel until a sufficient number of samplings have been recorded to identify one or more desired percentiles (e.g., fifth percentile and ninety-fifth percentile, etc.). As yet another example, a histogram may be used to sort metric samplings for each channel.

In embodiments, the headend device 105 can periodically generate a summary of metrics recovered for one or more individual upstream channels. For example, the headend device 105 can sample and record a metric for an upstream channel at a certain rate (e.g., metric can be recorded over a certain time duration, a packet burst, etc.), and a summary of the sampled metrics for the channel can be generated. The metric summary may be the mean value of metric samples recorded over a certain duration. In embodiments, the metric summary may be one or more percentiles (e.g., fifth percentile and ninety-fifth percentile, etc.) associated with the samples recorded for a metric. For example, a histogram associated with a metric may be used to determine one or more percentile values when a sufficient number of samples have been added to the histogram.

In embodiments, a messaging protocol (e.g., simple network management protocol (SNMP), etc.) may be used to communicate metric summaries between the headend device 105 and one or more CPE devices 110a-d. For example, a management information base (MIB) at the headend device 105 and/or CPE devices 110a-d may be used to store one or more MIB objects representing values for one or more metrics observed for each sub-carrier or channel. The headend device 105 or CPE device 110a-d can conditionally (e.g., based on a request for information, identification of a threshold value, etc.) or periodically retrieve a metric summary from an associated MIB using a MIB object identifier (OID), and can communicate the metric summary to a CPE device 110a-d or headend device 105 respectively.

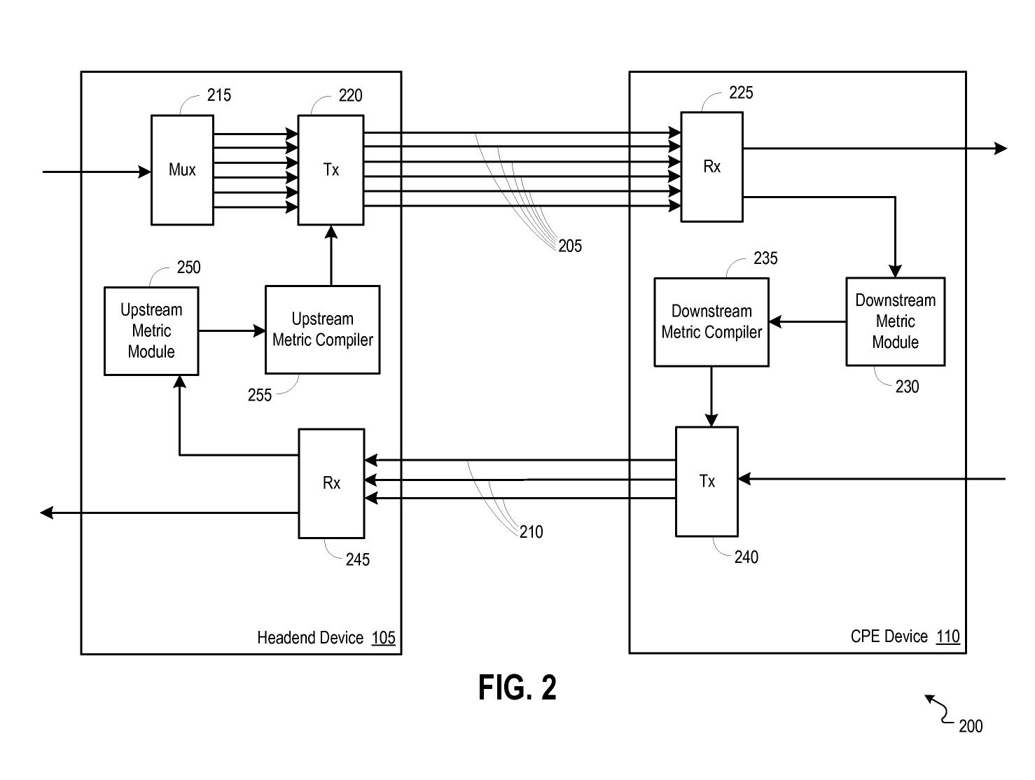

FIG. 2 is a block diagram illustrating an example system 200 operable to summarize metrics for a plurality of carriers. The system 200 may include a headend device 105 and one or more CPE devices 110 (e.g., CPE devices 110a-b of FIG. 1). Downstream communications may be transported from the headend device 105 to a CPE device 110 along one or more of a plurality of downstream sub-carriers 205, and upstream communications may be transported from a CPE device 110 to the headend device 105 along one or more of a plurality of upstream channels 210.

In embodiments, a signal may be received at a headend device 105 and multiplexed by a multiplexer 215. Received signals may be multiplexed using orthogonal frequency division multiplexing (OFDM), may be modulated onto one or more of a plurality of narrow sub-carriers, and the signals may be delivered to one or more CPE devices 110a-d along the plurality of downstream sub-carriers 205. Modulated signals may be output to a CPE device 110 along one or more downstream sub-carriers 205 by a transmitter 220.

In embodiments, a receiver 225 at a CPE device 110 may be used to receive a plurality of downstream sub-carriers 205 and modulated signal(s) transported along one or more of the downstream sub-carriers 205. A downstream metric module 230 may observe and/or record metrics (e.g., power level, SNR, error, etc.) associated with one or more of the received downstream sub-carriers 205. It will be appreciated by those skilled in the relevant art that various techniques may be used for observing and recording metrics associated with sub-carriers.

In embodiments, a downstream metric compiler 235 may sort observed sub-carrier metrics according to individual sub-carriers, and/or channels associated with the sub-carriers. The downstream metric module 230 may sample and record one or more metrics for each of a plurality of sub-carriers at a certain rate. The downstream metric compiler 235 may maintain a record for each sub-carrier, wherein the record includes values of metric samplings observed for the sub-carrier over a certain duration. As another example, the downstream metric compiler 235 may use a quick-select or variant algorithm to sort metric samplings for a sub-carrier until a sufficient number of samplings have been recorded to identify one or more desired percentiles (e.g., fifth percentile and ninety-fifth percentile, etc.). As yet another example, the downstream metric compiler 235 may use a histogram to sort metric samplings for each sub-carrier.

In embodiments, a downstream metric compiler 235 may periodically generate a summary of a metric observed for one or more individual sub-carriers. The downstream metric compiler 235 may periodically generate a summary of a metric observed for a downstream channel, wherein the summary is generated based upon the metrics observed for individual sub-carriers making up the channel. The metric summary may be the mean value of metric samples recorded over a certain duration. In embodiments, the metric summary may be one or more percentiles (e.g., fifth percentile and ninety-fifth percentile, etc.) associated with the samples recorded for a metric. For example, a histogram associated with a metric may be used to determine one or more percentiles when a sufficient number of samples have been added to the histogram.

In embodiments, a metric summary may be sent through a transmitter 240 of a CPE device 110 to the headend device 105 along one or more upstream channels 210. The one or more upstream channels 210 may also be used to carry upstream communications from the CPE device 110 to the headend device 105. It will be appreciated by those skilled in the relevant art that various protocols and/or standards may be used to communicate a metric summary from a CPE device 110 to a headend device 105.

In embodiments, a receiver 245 at a headend device 105 may be used to receive a plurality of upstream channels 210 and signal(s) transported along one or more of the upstream channels 210. An upstream metric module 250 may observe and/or record metrics (e.g., power level, SNR, error, etc.) associated with one or more of the received upstream channels 210. It will be appreciated by those skilled in the relevant art that various techniques may be used for observing and recording metrics associated with upstream channels.

In embodiments, an upstream metric compiler 255 may sort observed channel metrics according to individual upstream channels. The upstream metric module 250 may sample and record one or more metrics for each of a plurality of upstream channels at a certain rate. The upstream metric compiler 255 may maintain a record for each channel, wherein the record includes values of metric samplings observed for the respective upstream channel over a certain duration. As another example, the upstream metric compiler 255 may use a quick-select or variant algorithm to sort metric samplings for a channel until a sufficient number of samplings have been recorded to identify one or more desired percentiles (e.g., fifth percentile and ninety-fifth percentile, etc.). As yet another example, the upstream metric compiler 255 may use a histogram to sort metric samplings for each channel.

In embodiments, an upstream metric compiler 255 may periodically generate a summary of a metric observed for one or more individual upstream channels. A metric summary may be generated for a bonded upstream channel group, wherein the metric summary is generated based on metrics observed for each upstream channel making up the bonded upstream channel group. The metric summary may be the mean value of metric samples recorded over a certain duration. In embodiments, the metric summary may be one or more percentiles (e.g., fifth percentile and ninety-fifth percentile, etc.) associated with the samples recorded for a metric. For example, a histogram associated with a metric may be used to determine one or more percentiles when a sufficient number of samples have been added to the histogram.

In embodiments, a metric summary may be sent through a transmitter 220 of the headend device 105 to a CPE device 110 along one or more downstream sub-carriers 205. It will be appreciated by those skilled in the relevant art that various protocols and/or standards may be used to communicate a metric summary from a headend device 105 to a CPE device 110.

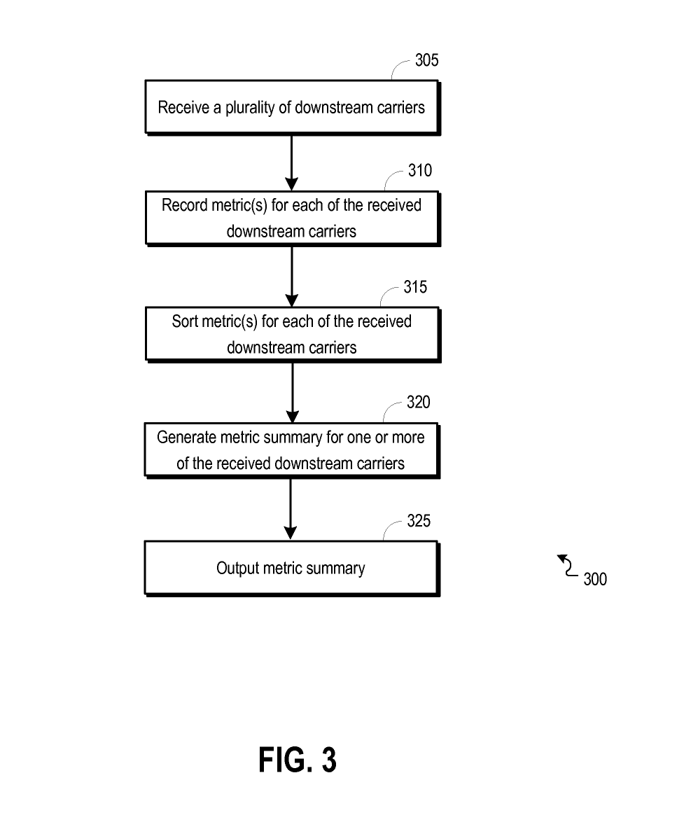

FIG. 3 is a flowchart illustrating an example process 300 operable to summarize metrics for a plurality of downstream carriers. The process 300 can begin at 305 when a plurality of downstream carriers is received. In embodiments, a CPE device 110a-d of FIG. 1 may receive a signal carried over one or more of a plurality of downstream carriers. For example, a CPE device 110a-d may receive downstream signals over one or more of a plurality of downstream sub-carriers (e.g., narrow sub-carriers generated using OFDM). A downstream channel may include a plurality of downstream sub-carriers.

At 310, metrics may be recorded for each of the received downstream carriers. In embodiments, a CPE device 110a-d may observe and/or record metrics (e.g., power level, SNR, error, etc.) associated with signals received along one or more of the received downstream channels or sub-carriers respectively. It will be appreciated by those skilled in the relevant art that various techniques may be used for observing and recording metrics associated with carriers.

At 315, observed metrics may be sorted according to individual carriers. One or more metrics may be sampled and recorded for each of a plurality of carriers (e.g., downstream sub-carriers, downstream channels, etc.) at a certain rate. In embodiments, a CPE device 110a-d may maintain a record for each carrier, wherein the record includes values of metric samplings observed for the carrier over a certain duration. A quick-select or variant algorithm may be used to sort metric samplings for a carrier until a sufficient number of samplings have been recorded to identify one or more desired percentiles (e.g., fifth percentile and ninety-fifth percentile, etc.). As another example, a histogram may be used to sort metric samplings for each carrier.

At 320, a summary of a metric observed for one or more individual carriers may be generated. In embodiments, a metric summary may be generated by a CPE device 110a-d based upon metrics observed and/or recorded at the CPE device 110a-d. For example, a metric summary may be generated by a downstream metric compiler 235 of FIG. 2. The metric summary may be a summary of metrics observed over a channel, wherein the summary is generated based upon metrics observed over each sub-carrier making up the channel. The metric summary may be the mean value of metric samples recorded over a certain duration. The metric summary may be one or more percentiles (e.g., fifth percentile and ninety-fifth percentile, etc.) associated with the samples recorded for a metric. For example, a histogram associated with a metric may be used to determine one or more percentiles when a sufficient number of samples have been added to the histogram. It should be understood that a metric summary may be generated periodically (e.g., based on time duration, packet burst duration, etc.) or conditionally (e.g., based on a request for a summary, receiving a large enough sample size, identifying a metric outside of a predetermined threshold, etc.).

At 325, a metric summary may be output. In embodiments, a metric summary of metrics observed for a carrier may be output to a device from which the carrier is transmitted. A metric summary of metrics observed for a downstream sub-carrier may be output from a CPE device 110a-d receiving the sub-carrier to a headend device 105 from which the sub-carrier was transmitted. It will be appreciated by those skilled in the relevant art that various protocols and/or standards may be used to communicate metric summaries between a CPE device 110a-d and a headend device 105.

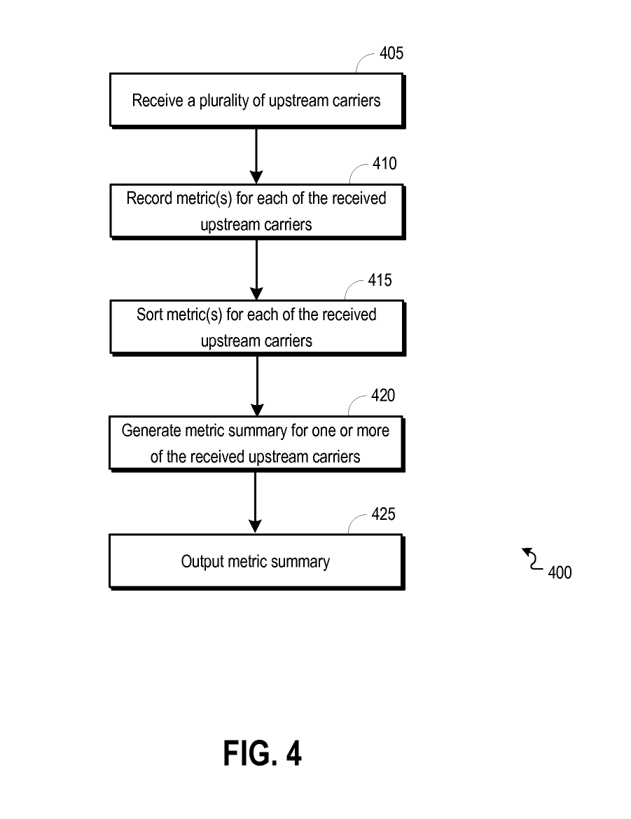

FIG. 4 is a flowchart illustrating an example process 400 operable to summarize metrics for a plurality of upstream carriers. The process 400 can begin at 405 when a plurality of upstream carriers is received. In embodiments, a headend device 105 of FIG. 1 may receive a signal carried over one or more of a plurality of carriers. For example, a headend device 105 may receive upstream signals over one or more of a plurality of upstream channels, and signals may be received over a group of bonded upstream channels.

At 410, metrics may be recorded for each of the received upstream carriers. In embodiments, a headend device 105 may observe and/or record metrics (e.g., power level, SNR, error, etc.) associated with signals received along one or more of the received upstream channels. It will be appreciated by those skilled in the relevant art that various techniques may be used for observing and recording metrics associated with carriers.

At 415, observed metrics may be sorted according to individual upstream carriers. One or more metrics may be sampled and recorded for each of a plurality of upstream carriers (e.g., upstream channels, bonded group of upstream channels, etc.) at a certain rate. In embodiments, a headend device 105 may maintain a record for each upstream carrier, wherein the record includes values of metric samplings observed for the carrier over a certain duration. A quick-select or variant algorithm may be used to sort metric samplings for a carrier until a sufficient number of samplings have been recorded to identify one or more desired percentiles (e.g., fifth percentile and ninety-fifth percentile, etc.). As another example, a histogram may be used to sort metric samplings for each carrier.

At 420, a summary of a metric observed for one or more individual upstream carriers may be generated. In embodiments, a metric summary may be generated by a headend device 105 based upon metrics observed and/or recorded at the headend device 105. For example, a metric summary may be generated by an upstream metric compiler 255 of FIG. 2. The metric summary may be a summary of metrics observed over a channel or bonded channel group, wherein the summary is generated based upon metrics observed over each channel or each channel making up the bonded group. The metric summary may be the mean value of metric samples recorded over a certain duration. The metric summary may be one or more percentiles (e.g., fifth percentile and ninety-fifth percentile, etc.) associated with the samples recorded for a metric. For example, a histogram associated with a metric may be used to determine one or more percentiles when a sufficient number of samples have been added to the histogram. It should be understood that a metric summary may be generated periodically (e.g., based on time duration, packet burst duration, etc.) or conditionally (e.g., based on a request for a summary, receiving a large enough sample size, identifying a metric outside of a predetermined threshold, etc.).

At 425, a metric summary may be output. In embodiments, a metric summary of metrics observed for a carrier may be output to a device from which the carrier is transmitted. A metric summary of metrics observed for an upstream channel or bonded upstream channel group may be output from a headend device 105 receiving the channel to a CPE device 110a-d from which a signal is transmitted along the channel or group. It will be appreciated by those skilled in the relevant art that various protocols and/or standards may be used to communicate metric summaries between a CPE device 110a-d and a headend device 105.

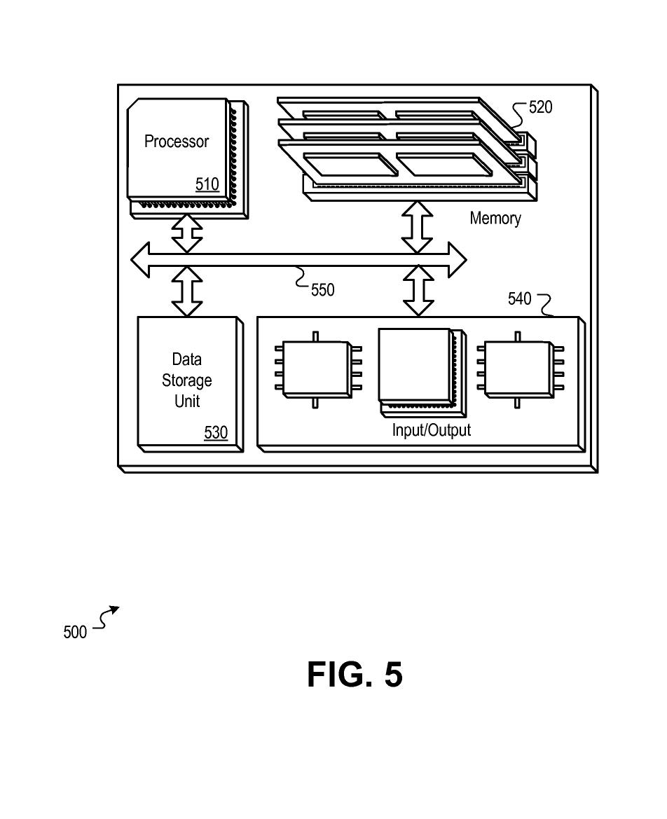

FIG. 5 is a block diagram of a hardware configuration 500 operable to summarize metrics for a plurality of carriers. The hardware configuration 500 can include a processor 510, a memory 520, a storage device 530, and an input/output device 540. Each of the components 510, 520, 530, and 540 can, for example, be interconnected using a system bus 550. The processor 510 can be capable of processing instructions for execution within the hardware configuration 500. In one implementation, the processor 510 can be a single-threaded processor. In another implementation, the processor 510 can be a multi-threaded processor. The processor 510 can be capable of processing instructions stored in the memory 520 or on the storage device 530.

The memory 520 can store information within the hardware configuration 500. In one implementation, the memory 520 can be a computer-readable medium. In one implementation, the memory 520 can be a volatile memory unit. In another implementation, the memory 520 can be a non-volatile memory unit.

In some implementations, the storage device 530 can be capable of providing mass storage for the hardware configuration 500. In one implementation, the storage device 530 can be a computer-readable medium. In various different implementations, the storage device 530 can, for example, include a hard disk device, an optical disk device, flash memory or some other large capacity storage device. In other implementations, the storage device 530 can be a device external to the hardware configuration 500.

The input/output device 540 provides input/output operations for the hardware configuration 500. In embodiments, the input/output device 540 can include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 802.11 card), and/or one or more interfaces for providing video, data, and/or voice services to a client device and/or a customer premise equipment device. In embodiments, the input/output device 540 can include driver devices configured to send communications to, and receive communications from one or more networks (e.g., subscriber network 120 of FIG. 1, WAN 125 of FIG. 1, etc.).

Those skilled in the art will appreciate that the invention improves upon methods and systems for monitoring signal metrics observed at a device. The methods, systems, and apparatuses described in this disclosure enable the reporting and monitoring of summarized metrics for a plurality of carriers. Metrics for one or more of a plurality of carriers can be observed and/or recorded based on measurements taken of one or more signals received along one or more of the plurality of carriers. Observed metrics may be sorted according to an associated carrier. A summary of observed metrics may be generated such that the metric summary can provide a glimpse of the quality of the carriers and an alert of any issues that might exist on the carriers.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD ROM disks. The processor and the memory can be supplemented by, or incorporated in, special purpose logic circuitry.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

We claim:

1. A method comprising:
receiving one or more signals along a plurality of carriers;
recording a plurality of measurements taken for a metric of each signal;
sorting each respective measurement according to the one or more carriers along which the one or more signals associated with the respective measurement is received; and
generating a metric summary based upon the plurality of measurements, wherein the metric summary communicates a summary of the measurements taken for the metric for signals received along one or more of the plurality of carriers.

2. The method of claim 1, wherein the plurality of carriers comprises narrow downstream sub-carriers.

3. The method of claim 2, wherein one or more of the narrow downstream sub-carriers is associated with a downstream channel, and the metric summary comprises a summary of the metric observed for each narrow downstream sub-carrier associated with the downstream channel.

4. The method of claim 1, wherein the plurality of measurements are sorted using a variant algorithm.

5. The method of claim 1, wherein the plurality of measurements are sorted using a histogram.

6. The method of claim 1, wherein the metric summary comprises the mean value of the plurality of measurements observed for one or more of the plurality of carriers.

7. The method of claim 1, wherein the metric summary comprises one or more percentile values of the plurality of measurements observed for one or more of the plurality of carriers.

8. The method of claim 1, wherein a metric summary is generated for each respective carrier, and the metric summary is based upon measurements taken for a metric associated with the respective carrier.

9. The method of claim 1, further comprising:
outputting the metric summary to a device from which the plurality of carriers is received.

10. An apparatus comprising:
an interface configured to be used to receive one or more signals along a plurality of carriers; and
a module configured to:
record a plurality of measurements taken for a metric of each signal;
sort each respective measurement according to the one or more carriers along which the one or more signals associated with the respective measurement is received; and
generate a metric summary based upon the plurality of measurements,
wherein the metric summary communicates a summary of the measurements taken for the metric for signals received along one or more of the plurality of carriers.

11. The apparatus of claim 10, wherein:
the plurality of carriers comprises narrow downstream sub-carriers;
one or more of the narrow downstream sub-carriers is associated with a downstream channel; and
the metric summary comprises a summary of the metric observed for each narrow downstream sub-carrier associated with the downstream channel.

12. The apparatus of claim 10, wherein the metric summary comprises the mean value of the plurality of measurements observed for one or more of the plurality of carriers.

13. The apparatus of claim 10, wherein the metric summary comprises one or more percentile values of the plurality of measurements observed for one or more of the plurality of carriers.

14. The apparatus of claim 10, further comprising:
an interface configured to be used to output the metric summary to a device from which the plurality of carriers is received.

15. One or more non-transitory computer readable media having instructions operable to cause one or more processors to perform the operations comprising:
receiving one or more signals along a plurality of carriers;
recording a plurality of measurements taken for a metric of each signal;
sorting each respective measurement according to the one or more carriers along which the one or more signals associated with the respective measurement is received; and
generating a metric summary based upon the plurality of measurements, wherein the metric summary communicates a summary of the measurements taken for the metric for signals received along one or more of the plurality of carriers.

16. The one or more non-transitory computer-readable media of claim 15, wherein:
the plurality of carriers comprises narrow downstream sub-carriers;
one or more of the narrow downstream sub-carriers is associated with a downstream channel; and
the metric summary comprises a summary of the metric observed for each narrow downstream sub-carrier associated with the downstream channel.

17. The one or more non-transitory computer-readable media of claim 15, wherein the plurality of measurements are sorted using a histogram.

18. The one or more non-transitory computer-readable media of claim 15, wherein the metric summary comprises the mean value of the plurality of measurements observed for one or more of the plurality of carriers.

19. The one or more non-transitory computer-readable media of claim 15, wherein the metric summary comprises one or more percentile values of the plurality of measurements observed for one or more of the plurality of carriers.

20. The one or more non-transitory computer-readable media of claim 15, wherein a metric summary is generated for each respective carrier, and the metric summary is based upon measurements taken for a metric associated with the respective carrier.
